(19) United States
(12) Patent Application Publication
(10) Pub. No.: US 2025/0337150 A1
(43) Pub. Date: Oct. 30, 2025

(54) MOUNTING ASSEMBLIES FOR RF ANTENNAS MOUNTED AT SKEWED AZIMUTH ANGLES

(71) Applicant: OUTDOOR WIRELESS NETWORKS LLC, Richardson, TX (US)

(72) Inventors: Jared HAINES, Rock City Falls, NY (US); Bin AI, Suzhou (CN); Chau BU, Suzhou (CN); Charles MANN, Omaha, NE (US)

(21) Appl. No.: 19/098,297

(22) Filed: Apr. 2, 2025

Related U.S. Application Data
(63) Continuation of application No. PCT/CN2024/090144, filed on Apr. 26, 2024.

(30) Foreign Application Priority Data
Aug. 23, 2024 (CN) 202411164066.4

(51) Int. Cl. H01Q 1/12; F16M 11/04

(52) U.S. Cl. CPC H01Q 1/12; F16M 11/048; F16M 2200/061

(57) ABSTRACT

An assembly for mounting a plurality of antennas includes: a horizontal pole; at least one member extending away from the horizontal pole; and at least two radio frequency antennas, wherein a first of the at least two antennas is mounted on the at least one member to define a first distance from the horizontal pole, and wherein a second of the at least two antennas is mounted a second distance from the horizontal pole that is less than the first distance from the horizontal pole. The first antenna and the second antenna are positioned and oriented so that they are substantially coplanar.

### RELATED APPLICATIONS

The present application is a continuation of and claims priority from and the benefit of International Application No. PCT/CN2024/090144, filed Apr. 26, 2024, and Chinese Patent Application No. 202411164066.4, filed Aug. 23, 2024, the disclosures of which are hereby incorporated herein in full.

### FIELD OF THE INVENTION

The present application is directed generally toward telecommunications equipment, and more particularly, a mounting arrangement for a monopole platform assembly and related platform assemblies.

### BACKGROUND OF THE INVENTION

Current sector frames and monopole antenna platforms utilize mounting poles or pipes to secure passive and active antennas thereto. An exemplary antenna platform is illustrated in FIG. 1. As shown in FIG. 1, the platform assembly 10 utilizes vertical mounting poles 14 to mount antennas 40 to one or more of the horizontal members or pipes 12 of the platform assembly 25.

Traditional monopole platforms have faces that are fixed relative to the azimuth angle. Optimally, the antennas 40 are installed parallel to the face of the mount (i.e., each antenna 40 is mounted such that its width dimension W is substantially parallel to the horizontal mounting pole 12 on which it is mounted and substantially coplanar with the width dimensions of the other antennas 40), which in turn means that the boresight of each antenna 40 is perpendicular to the horizontal mounting pole 12 (and to the width dimensions of the antennas 40). This arrangement typically applies to platforms (such as the platform assembly 10 of FIG. 1) or sector frames (such as that shown in U.S. Pat. No. 9,812,762, the disclosure of which is hereby incorporated herein).

In some instances, an azimuth angle is utilized that will not allow the antennas to be parallel to the face of the mount; as a result, a condition known as antenna “skew” results. This is exemplified in FIG. 2, wherein antennas 40′ are mounted such that their width dimensions W′ are not parallel to the horizontal pipe 12′ on which they are mounted. Although the width dimensions of the antennas 40′ are parallel to each other, they are not substantially coplanar as they are in the typical arrangement of FIG. 1. This arrangement can be problematic because the radio frequency (RF) pattern of the antennas 40′ can cause interference in performance (both from an RF perspective and a passive intermodulation (PIM) perspective).

In view of this, there may be a desire for alternative ways to mount the antenna unit on monopole platforms and sector frames.

### SUMMARY OF THE INVENTION

As a first aspect, embodiments of the present invention are directed to an assembly for mounting a plurality of antennas. The assembly comprises: a horizontal pole; at least one member extending away from the horizontal pole; and at least two radio frequency antennas, wherein a first of the at least two antennas is mounted on the at least one member to define a first distance from the horizontal pole, and wherein a second of the at least two antennas is mounted a second distance from the horizontal pole that is less than the first distance from the horizontal pole. The first antenna and the second antenna are positioned and oriented so that they are substantially coplanar.

As a second aspect, embodiments of the present invention are directed to an assembly for mounting a plurality of antennas comprising: a horizontal pole; and at least two radio frequency antennas, wherein a first of the at least two antennas is mounted to define a first distance from the horizontal pole, and wherein a second of the at least two antennas is mounted a second distance from the horizontal pole that is less than the first distance from the horizontal pole.

As a third aspect, embodiments of the invention are directed to an assembly for mounting a plurality of antennas comprising: a mounting platform; a horizontal pole attached to the mounting platform; at least two members extending away from the horizontal pole; and at least three radio frequency antennas, wherein a first of the at least three antennas is mounted on a first of the at least two members to define a first distance from the horizontal pole, and wherein a second of the at least three antennas is mounted on a second of the at least two members to define a second distance from the horizontal pole that is less than the first distance from the horizontal pole. The first antenna and the second antenna are positioned and oriented so that they are substantially coplanar.

As a fourth aspect, embodiments of the invention are directed to an assembly for mounting a plurality of antennas comprising: a horizontal pole defining a first axis; and at least two radio frequency antennas mounted in positions near the horizontal pole, the at least two radio frequency antennas defining a second axis that is non-parallel with the first axis.

As a fifth aspect, embodiments of the invention are directed to an assembly for mounting a plurality of antennas comprising: a mounting platform; a horizontal pole attached to the mounting platform; a member extending away from the horizontal pole; and a radio frequency antenna mounted on the member. The member is mounted to the horizontal pole to be selectively rotatable about a vertical axis.

### BRIEF DESCRIPTION OF THE FIGURES

FIG. 1 is a top view of a known monopole platform assembly.

FIG. 2 is a top view of a known monopole platform assembly of with antennas mounted in a skewed fashion.

FIG. 3 is a schematic top view of a monopole platform assembly with skew-mounted antennas according to embodiments of the invention.

FIG. 4 is a top view of a portion of a monopole platform assembly with skew-mounted antennas according to further embodiments of the invention.

FIG. 5 is a perspective view of an extension frame for the assembly of FIG. 4.

FIG. 6 is an enlarged top view of two sets of clamps employed with the extension frame of FIG. 5.

FIG. 7 is a perspective view of a portion of a monopole platform assembly with skew-mounted antennas according to further embodiments of the invention.

FIG. 8 is a top view of two extension units of the assembly of FIG. 7.

FIG. 9 is a side view of two extension units of the assembly of FIG. 7 employed to mount the same antenna.

FIG. 10 is a perspective view of a portion of the monopole platform assembly with skew mounted antennas according to still further embodiments of the invention.

FIG. 11 is a perspective view of a scissor-type mechanism for selectively positioning antennas on a monopole platform assembly according to further embodiments of the invention, the mechanism shown in an extended position.

FIG. 12 is a perspective view of the mechanism of FIG. 11 shown in a retracted position.

FIG. 13 is a perspective view of and articulating arm mechanism for selectively positioning antennas on a monopole platform assembly according to still further embodiments of the invention, the mechanism shown in a retracted position.

FIG. 14 is a perspective view of the mechanism of FIG. 13 shown in an extended position.

FIG. 15 is a perspective view of an extension frame for selectively positioning antennas on a monopole platform assembly according to still further embodiments of the invention.

FIG. 16 is a perspective view of a mounting bracket of the extension frame of FIG. 15.

FIG. 17 is a perspective view of a horizontal sliding member of the extension frame of FIG. 15.

FIG. 18 is a perspective view of a vertical pole of the extension frame of FIG. 15.

FIG. 19 is a perspective view of the extension frame of FIG. 15 used to mount an antenna at a selected distance from the mounting platform.

FIG. 20 is a perspective view of a mounting platform with skew-mounted antennas that utilize extension frames of FIG. 15.

FIG. 21 is a perspective view of an extension frame for selectively positioning antennas on a monopole platform assembly according to still further embodiments of the invention.

FIG. 22 is a perspective view of a mounting bracket of the extension frame of FIG. 21.

FIG. 23 is a perspective view of the extension frame of FIG. 21 used to mount an antenna at a selected distance from the mounting platform.

FIG. 24 is an enlarged perspective view of the mounting bracket and horizontal sliding member of the extension frame of FIG. 23.

FIG. 25 is a perspective view of a mounting platform with skew-mounted antennas that utilize extension frames of FIG. 21.

FIGS. 26A-H illustrate steps in adjusting standard antennas to a skew-mounted configuration utilizing extension frames of FIG. 21.

FIG. 27 is a schematic top view of a monopole platform assembly with skew-mounted antennas according to further embodiments of the invention.

FIG. 28 is a partial perspective views of an extension frame for the assembly of FIG. 27, wherein the extension frame has the ability to rotate about a vertical axis.

FIG. 29 is a schematic top view of a monopole platform assembly with skew-mounted antennas according to still further embodiments of the invention.

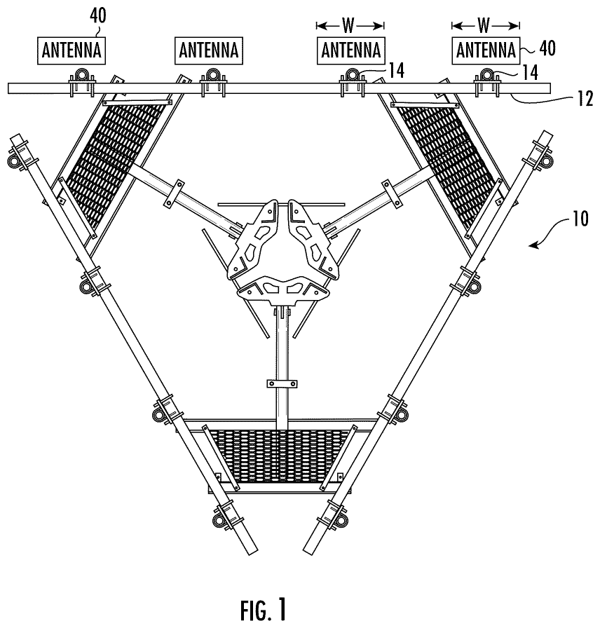

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown. Like numbers refer to like elements throughout and different embodiments of like elements can be designated using a different number of superscript indicator apostrophes (e.g., 10′, 10″, 10′″).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

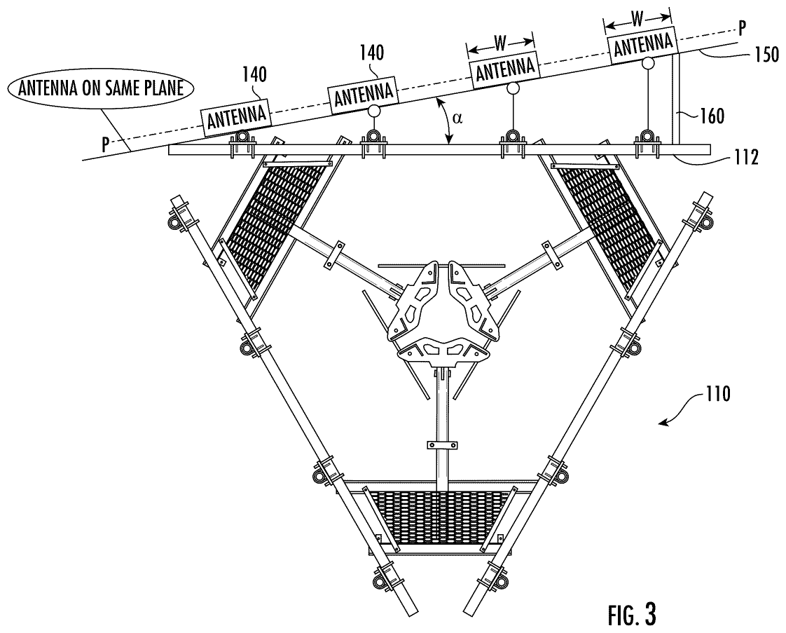

Pursuant to embodiments of the present invention, platform assemblies and sector frames are provided that enable antennas to be mounted thereon such that their faces both are substantially parallel and substantially coplanar, thereby helping to reduce interference among RF signals sent from or received by the respective antennas. Referring now to FIG. 3, a schematic representation of a monopole platform assembly 110 with antennas 140 mounted according to embodiments of the invention is shown therein. As can be seen in FIG. 3, the monopole platform assembly 110 includes a horizontal mounting member 150 that is attached to a horizontal pole 112 one that side of the assembly 110 but is disposed at a non-zero angle relative to the horizontal pole 112. The mounting member 150 is disposed at an angle α that matches the desired azimuth angle at which the antennas 140 are oriented (i.e., the antennas 140 are all also oriented at the angle a relative to the horizontal pole 112). This arrangement allows the mounted antennas 140 to be substantially coplanar (i.e., their width dimensions are substantially coplanar along a plane P), which in turn can prevent the potential RF and PIM interference that might result from non-coplanar antennas.

In such an arrangement, it may be beneficial for the horizontal member 150 to be supported at both ends. For example, the end of the horizontal member 150 that is spaced from the horizontal pole 112 may be fixed to the horizontal pole 112 via a support member, such as the support member 160 shown in FIG. 3.

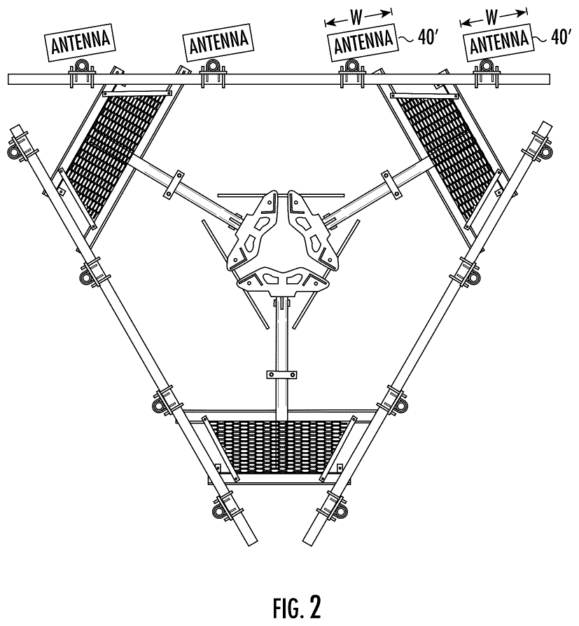

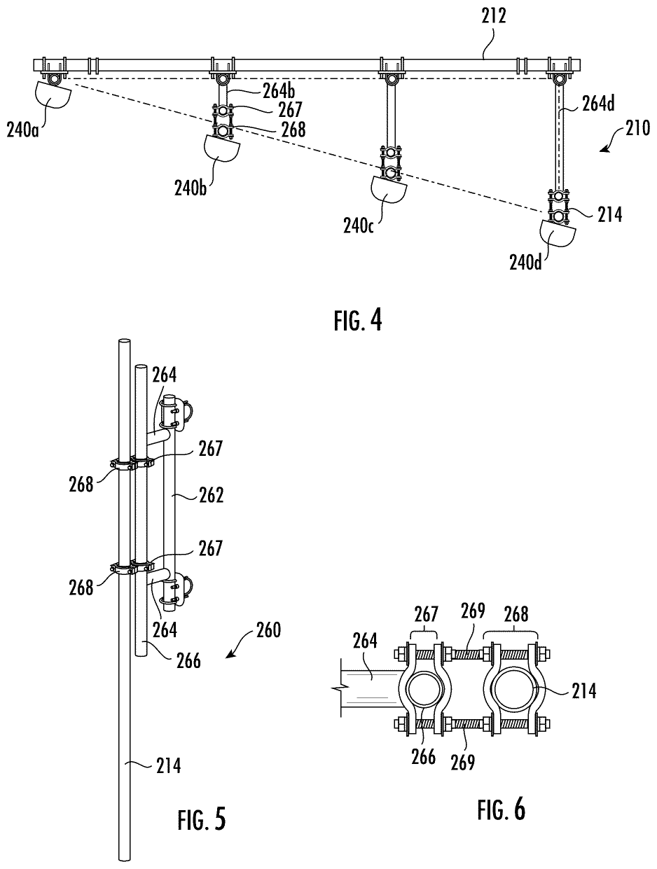

There may be other configurations that enable antennas to be deployed at a desired skewed azimuth angle. Referring now to FIGS. 4-6, one sector of a monopole platform assembly, designated broadly at 210, is shown therein. The assembly 210 includes four antennas 240 that are to be mounted at a skewed azimuth angle (i.e., not parallel with the horizontal pole 212 that defines an edge of the platform). In this arrangement, one of the antennas 240a is mounted to a typical vertical pole 214 that is mounted to the horizontal pole 212 in the manner described above in connection with FIG. 2. However, each of the other antennas 240b, 240c, 240d is mounted on a vertical pole 214 that is in turn mounted to a respective extension frame 260 (see FIG. 5), each of which has an inward vertical member 262 that is mounted to the horizontal pole 212, two horizontal arms 264 and an outward vertical member 266. The vertical pole 214 is mounted to the outward vertical member 266 via two sets of clamp pairs 267, 268 that are connected via threaded rods 269 (see FIG. 6). The arms 264 of different extension frames 260 are of different lengths (compare arm 264b with arm 264d in FIG. 4) in order to enable the antennas 260b-260d to be mounted at increasing distances from the horizontal pole 212. The antennas 260a-260d are mounted on their respective vertical poles 214 an at angular orientation that enables the width dimensions of the antennas 260a-260d to be substantially coplanar.

Notably, the clamp 268 permits the vertical pole 214 to rotate about its axis, which enables a technician to precisely align the antenna 240 to the desired azimuth angle before securing it in place. Also, the presence of the threaded rods 269 between the clamps 267, 268 allows fine adjustment of the distance of each vertical pole 214 (and in turn each antenna 240) from the horizontal pole 212 in order to precisely position each antenna 240.

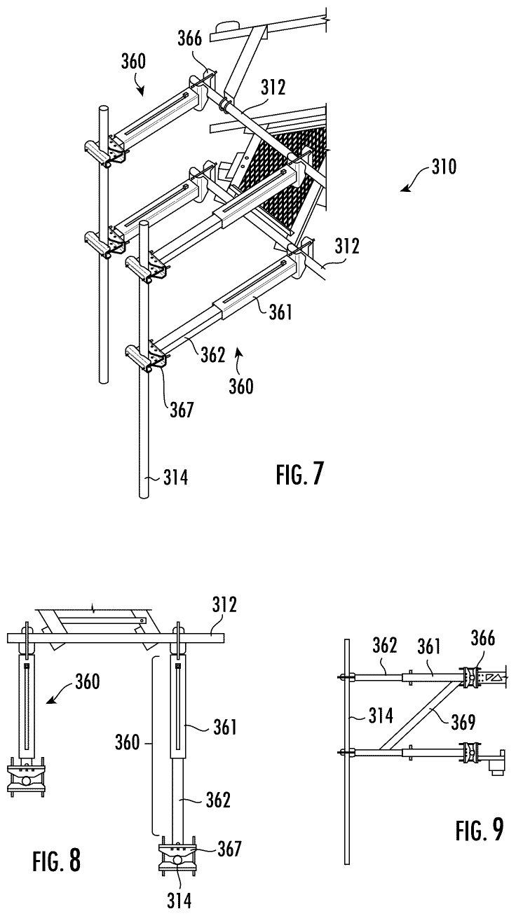

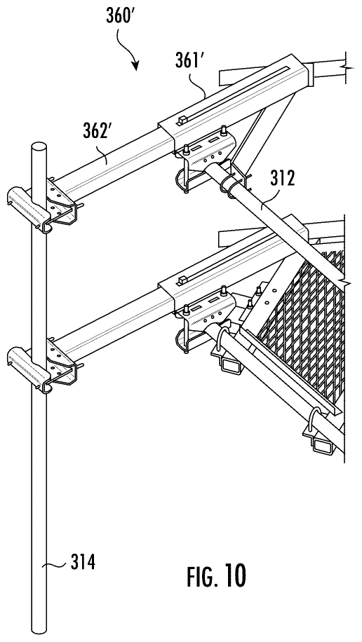

FIGS. 7-9 illustrate a portion of another monopole assembly, designated broadly at 310, that is suitable for use with antennas having a skewed azimuth angle. The assembly 310 includes extendable units 360 that comprise members 361, 362 that can slide relative to each other to vary the overall length of the units 360. The extendable units 360 are mounted via clamps 366 at one end to a horizontal pole 312 of the assembly 310, and at the opposite end to via clamp pairs 367 to a vertical pole 314 on which is mounted an antenna (the antenna is not shown in FIGS. 7-9). As shown in FIG. 8, the overall length of the extendable units 360 can be varied by sliding the slidable member 361 relative to the slidable member 362 and securing it in place (e.g., with a bolt or the like). This adjustability enables antennas mounted thereon to be positioned at distances that permit their width dimensions to be substantially coplanar when the antennas are rotated to the desired azimuth angle. FIG. 9 illustrates that in some embodiments upper and lower extendable units 360 that are attached to the same vertical pole 314 may be stabilized by a stabilizer bar 369 or a similar mechanism.

As shown in FIG. 10, in some embodiments the slidable member 361′ of the extendable unit 360′ may be fixed to the horizontal pole 312 at its forward end. The slidable member 362′ is attached to a vertical pole 314 as described above. This arrangement may provide less overall extension away from the horizontal pole 312 than the extendable unit 360, but can be used in instances when the antenna should be positioned at less than the length of the extendable unit 360 when the slidable member 361 is fully retracted.

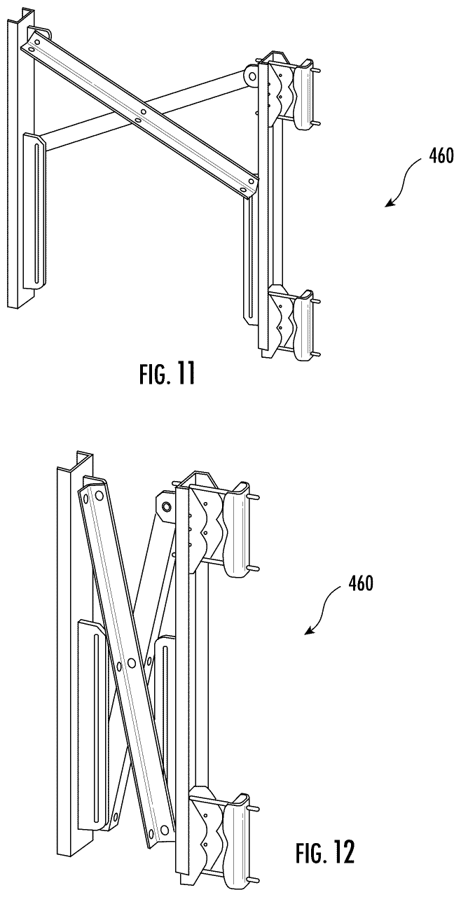

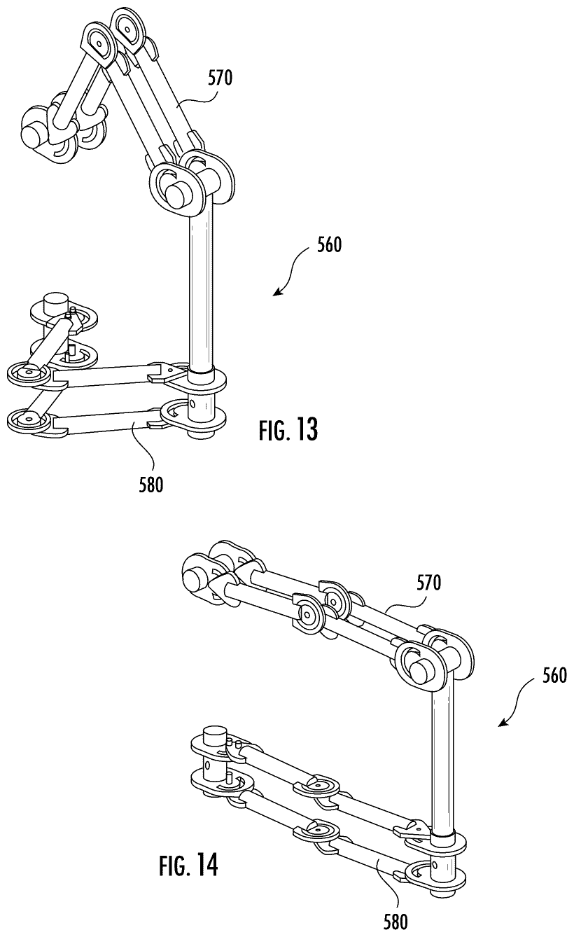

Additional mechanisms for selectively extending the distance of the antenna from the horizontal pole of the platform are shown in FIGS. 11-14. As one example, FIGS. 11 and 12 illustrates an “accordion” or “scissors”-style mechanism 460 that can be used to selectively position an antenna a distance from the horizontal pole of the assembly. As another example, articulating arm mechanisms 560 (FIGS. 13 and 14) may be employed. One characteristic of the articulating arms mechanism 560 that may be beneficial is that the links of the upper linkage 570 rotate about horizontal axes, whereas the links of the lower linkage 580 rotate about vertical axes. As a result, the combined assembly may have greater strength and stiffness, in multiple directions, which may be important in withstanding wind loads.

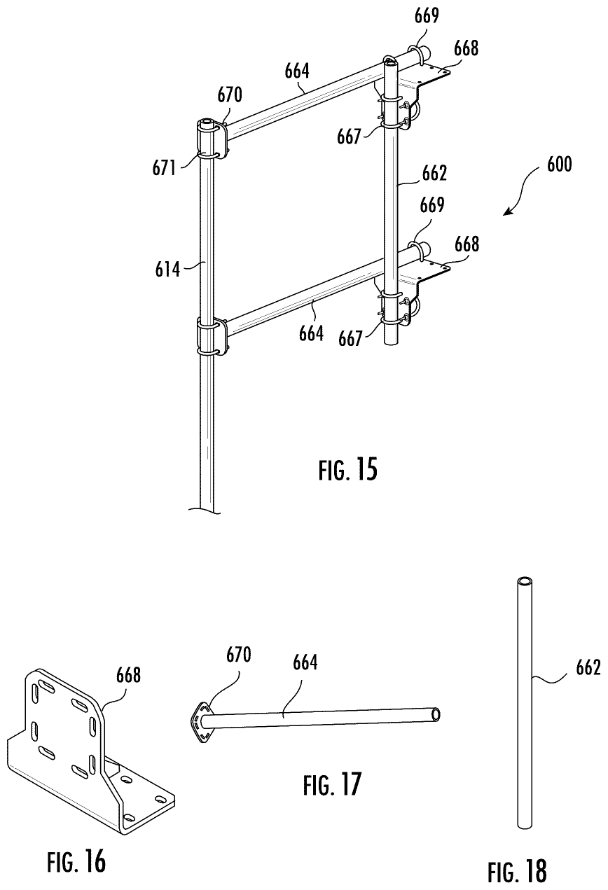

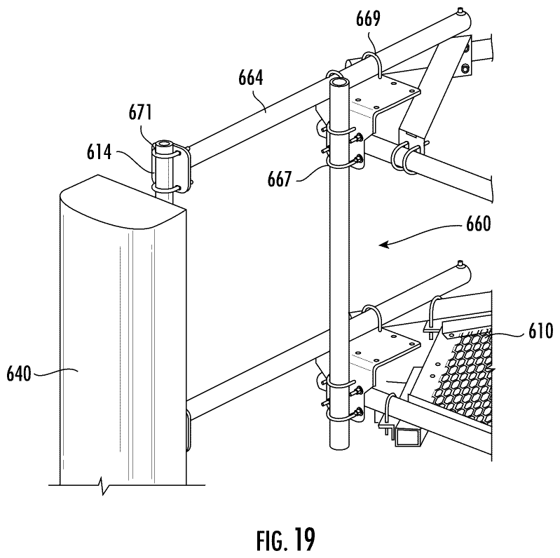

FIGS. 15-20 illustrate another embodiment of an extension frame, which is designated broadly at 660. The antenna frame 660 includes a vertical member 662 and two horizontal sliding members 664 which are attached to the vertical member 662 via L-shaped brackets 668 and U-bolts 667. Each of the sliding horizontal members 664 is attached to the L-shaped brackets 668 with U-bolts 669. Thus, the sliding horizontal members 664 can be loosely captured with the U-bolts 669, but are able to slide relative to the mounting brackets 668 until being tightened in place once a desired position is reached (see FIGS. 15 and 19).

As shown in FIG. 17, each of the sliding horizontal members 664 has a mounting plate 670 attached at one end. An antenna pole 614 is mounted to the mounting plates 670 of the sliding horizontal members 664 with U-bolts 671. The antenna pole 614 (and in turn any antenna 640 mounted thereto) may be rotated within the U-bolts 671 to a desired angle (e.g., a skewed angle as described above) before being fixed in that orientation by tightening the U-bolts 671 (see FIGS. 15 and 19).

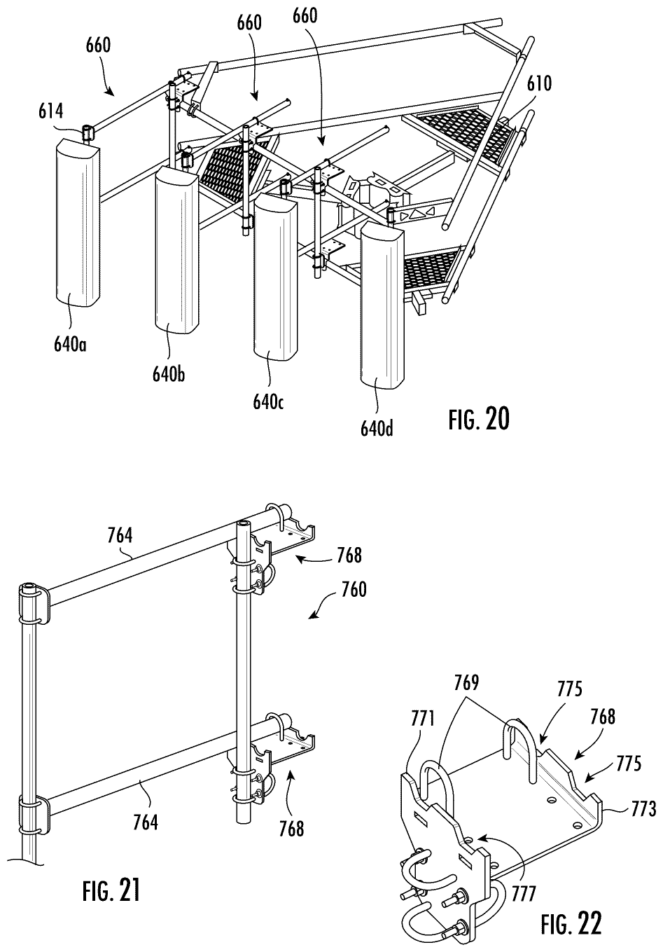

As shown in FIG. 20, the extension frames 660 can be used to mount antennas at different distances from a mounting platform 610. The antenna 640d on the far right of FIG. 20 may be mounted directly to an antenna pole 614 of the mounting platform 610 without the remainder of the extension frame 660, but the antennas 640a, 640b, and 640c are each mounted via a respective extension frame 660 at a different distance from the mounting platform 610 to facilitate skew-mounting of the antennas 640a-d. In each instance, the antenna 640a-d is rotated about its antenna pole 614 to the desired azimuth angle.

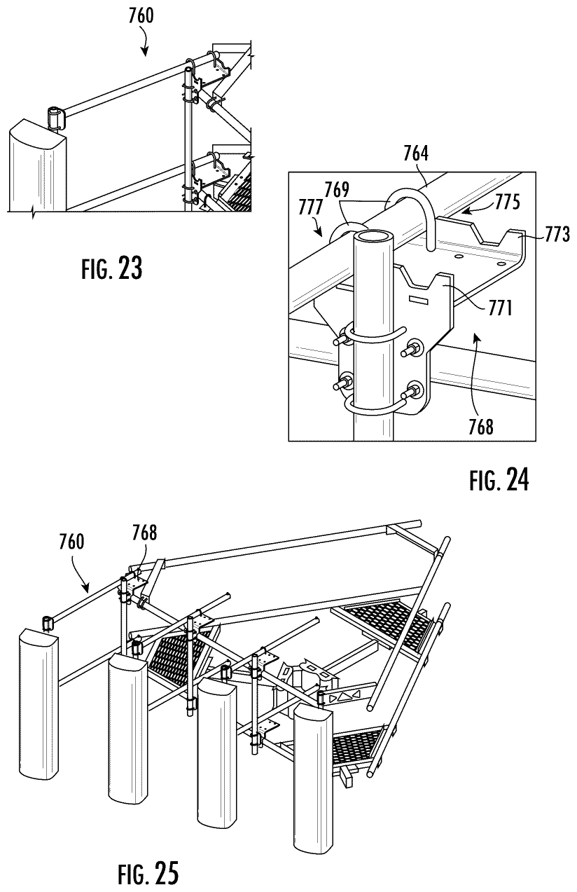

Referring now to FIGS. 21-25, another extension frame, designated broadly at 760, is shown therein. The extension frame 760 is similar to the extension frame 660 with the exception that the L-shaped bracket 668 is replaced with a bracket 768 that includes two upwardly-extending flanges 771, 773, each of which includes respective notches 775, 777. As shown in FIGS. 23 and 24, the slidable horizontal members 764 are received in an aligned set of notches 775, 777. The interaction of the horizontal slidable members 764 with the notches 775, 777 facilitates the positioning of the slidable horizontal members 764 as they are being positioned during installation prior to being fixed in place with the U-bolts 769 (particularly as the slidable horizontal members 764 slide within the loosened U-bolts 769).

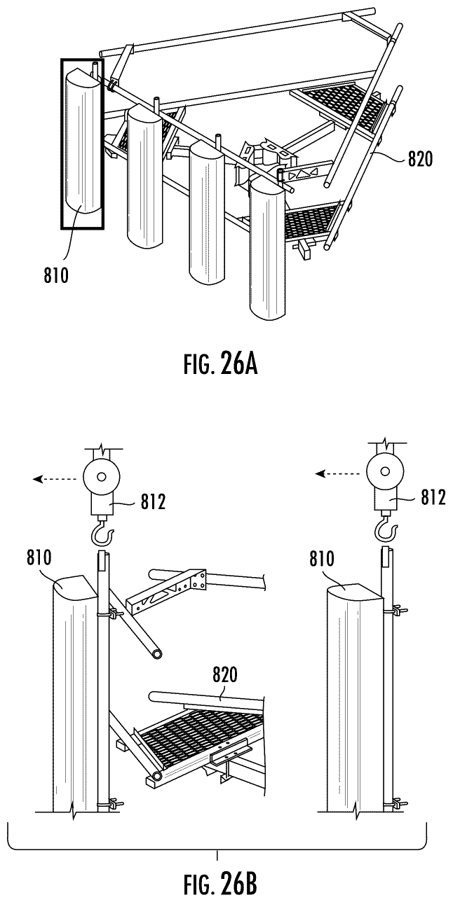

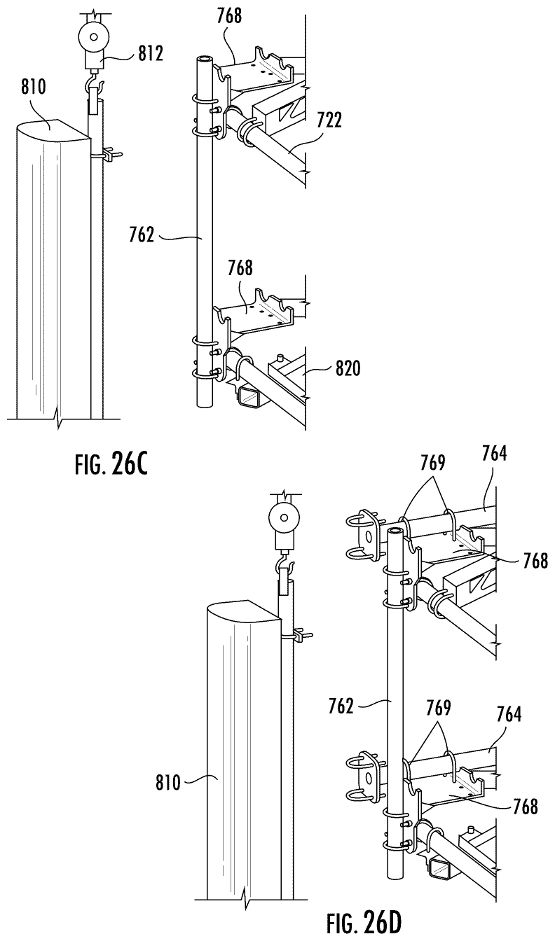

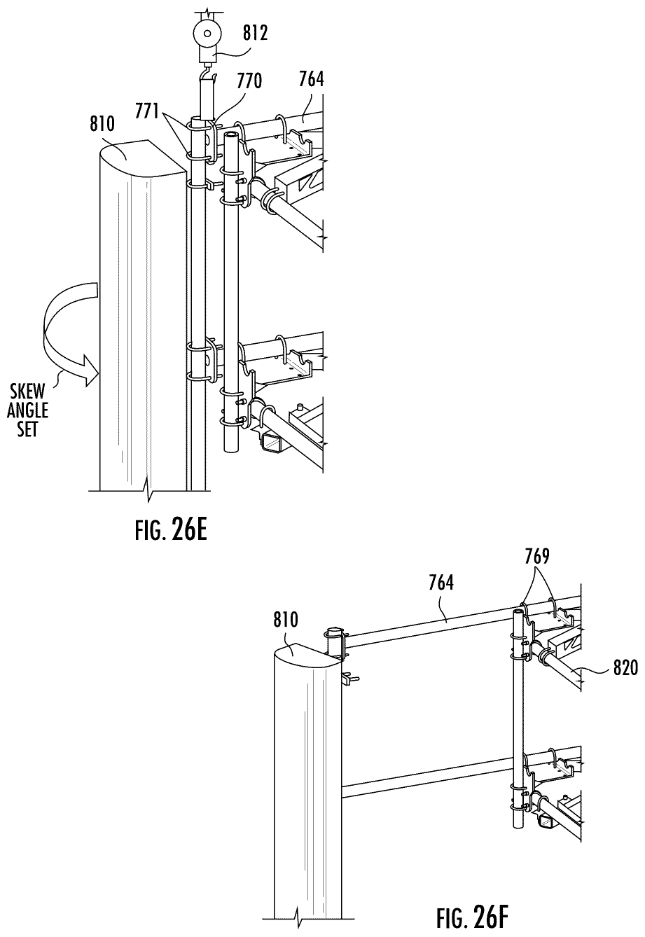

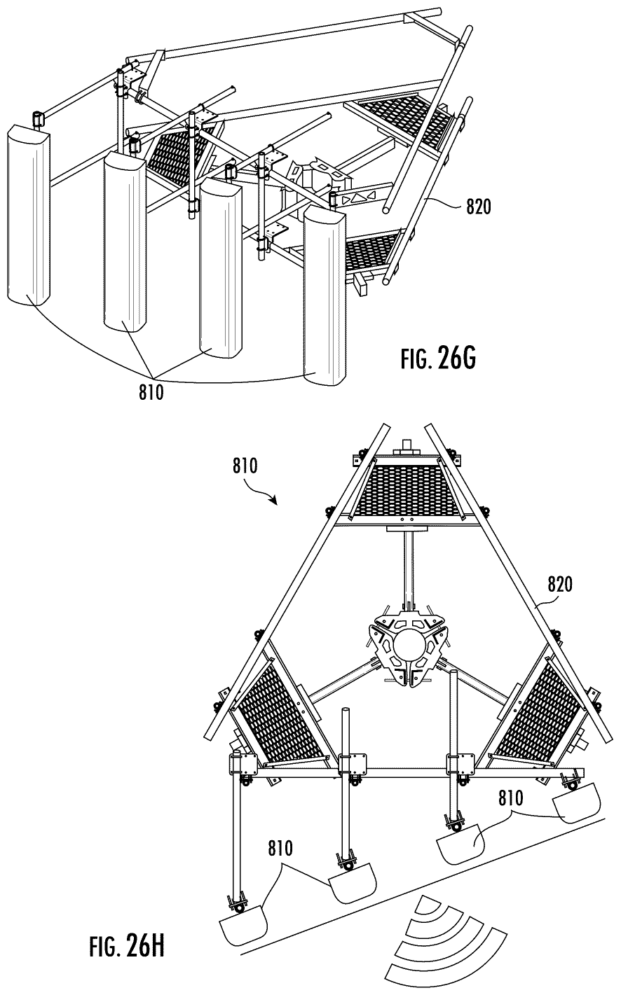

Conversion of a conventional to a skew-mounted arrangement can be understood through reference to FIGS. 26A-H. Starting with a conventional arrangement of antennas 810 on a mounting platform 820, the leftmost antenna 810 in FIG. 26A is used as an example. First, the antenna 810 is hoisted (e.g., with a hoisting grip 812) after being disconnected from the platform 820 (FIG. 26B). The mounting brackets 768 and the vertical member 762 are mounted to the horizontal poles 722 of the mounting platform 820 (FIG. 26C). The sliding horizontal members 764 are then loosely mounted to the mounting brackets 768 with U-bolts 769 (FIG. 26D). The antenna 810 is attached to the mounting plates 770 of the horizontal sliding members 764 with U-bolts 771 (FIG. 26E), the skew angle for the antenna 810 is set (typically with a GPS-based device for aiming antennas), and the U-bolts 771 are tightened to fix the antenna 810 and antenna pole 714 on the mounting plates 770. The antenna 810 is then positioned (by sliding the horizontal sliding members 764 within the U-bolts 769) at the desired distance from the mounting platform 820 (FIG. 26F). The U-bolts 769 are tightened to fix the antenna 810 at the desired distance, and the hoisting grip 812 is removed). This process is repeated for each of the antennas 810 that are to be positioned some distance away from the mounting platform 820 (FIGS. 26G and 26H). The resulting arrangement can provide the advantages of a skewed mounting of antennas as described above.

Those of skill in this art will appreciate that, although FIGS. 26A-26H are directed to retrofitting an existing antenna arrangement to a skewed arrangement as shown, the steps may also be followed to mount new antennas.

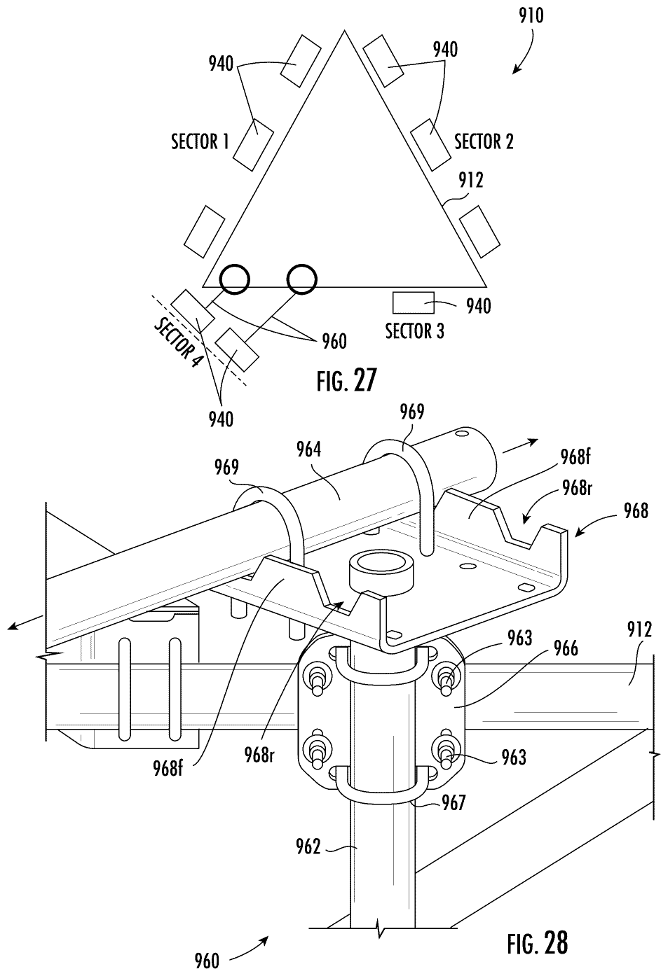

Referring now to FIGS. 27 and 28, another monopole platform assembly, designated broadly at 910, is shown therein. FIG. 27 schematically illustrates how the platform assembly 910 may have antennas 940 that are mounted to be generally parallel with the sides of the platform 912, but in addition may have one or more additional antennas 940′ that are mounted at a skewed angle relative to the side of the platform 912. To achieve the skewed configuration, the platform assembly 910 includes extension frames 960 that are mounted to the platform 912 to be rotatable about a vertical axis V. As a result, and as seen in FIG. 27, this capability can enable the platform assembly 910 to have more than three sectors, i.e., there can be a sector that is parallel with each side of the platform 912 (listed as Sectors 1, 2 and 3 in FIG. 27), plus additional sectors (one additional sector, Sector 4, including antennas 940′ is shown in FIG. 27) may also be included. As a result, the monopole assembly 910 can support more than the conventional three sectors should such a configuration be desirable.

Referring now to FIG. 28, a portion of an extension frame 960 is shown therein. The extension frame 960 includes a vertical pole 962 that is mounted at each end to a respective horizontal pole 912 that represents the platform. A vertical bracket 966 is mounted to the horizontal pole 912 via U-bolts 963, and the vertical pole 962 is mounted to the vertical bracket via U-bolts 967. A horizontal bracket 968 is fixed to each end of the vertical pole 962 and rotates with the pole 962. The horizontal bracket 968 has flanges 968f on opposite sides, with each flange 968f including two recesses 968r. As shown in FIG. 28, a horizontal sliding member 964 (which may be identical to the horizontal sliding members 664 discussed above) can be mounted to each of the horizontal brackets 668 via U-bolts 969, with the horizontal sliding members fitting into two aligned slots 968r. This type of joint between the horizontal sliding members 964 and the horizontal brackets 968 enables the horizontal sliding members 964 to slide relative to the horizontal brackets 968 (indicated by the arrows in FIG. 28), such that an antenna 940′ can be mounted on the ends of the horizontal sliding members 964 at various distances from the horizontal pole 912 in much the same manner as described above for the extension frame 660. In addition, though, the mounting of the vertical pole 962 within the U-bolts 967 can enable the vertical pole 962, and therefore the entire extension frame 960, to be rotated about the axis V so that the angular position of the antenna 940′ can be adjusted relative to the platform 912.

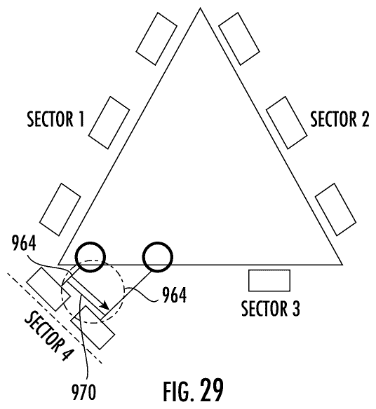

In some embodiments, it may be desirable to support the rotated extension frame 960 in some manner to prevent it from rotating after its position has been established. One way of doing so is to include a tie bar or the like that is fixed to the horizontal sliding member 964 and the horizontal pole 912. Another supporting configuration is shown in FIG. 29, wherein a tie bar or similar member 970 is joined to span the horizontal sliding members 964 of adjacent extension frames 960.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. An assembly for mounting a plurality of antennas, comprising:
a horizontal pole;
at least one member extending away from the horizontal pole; and
at least two radio frequency antennas, wherein a first of the at least two antennas is mounted on the at least one member to define a first distance from the horizontal pole, and
wherein a second of the at least two antennas is mounted a second distance from the horizontal pole that is less than the first distance from the horizontal pole;
wherein the first antenna and the second antenna are positioned and oriented so that they are substantially coplanar.

2. The assembly defined in claim 1, wherein the at least one member is two members, and wherein the first antenna is mounted on a first one of the members, and wherein the second antenna is mounted on a second one of the two antennas.

3. The assembly defined in claim 2, wherein a third of the at least two antennas is mounted adjacent the horizontal pole.

4. The assembly defined in claim 1, wherein the at least one member is configured to be adjustable so that the first distance can be selected.

5. The assembly defined in claim 4, wherein the at least one member comprises an articulated arm.

6. The assembly defined in claim 4, wherein the at least one member comprises a scissors-type linkage.

7. The assembly defined in claim 1, wherein the at least one member comprises a telescoping extension unit.

8. The assembly defined in claim 1, wherein the horizontal pole is attached to a monopole platform.

9. The assembly defined in claim 1, wherein the horizontal pole is attached to a sector frame.

10. An assembly for mounting a plurality of antennas, comprising:
a horizontal pole; and
at least two radio frequency antennas, wherein a first of the at least two antennas is mounted to define a first distance from the horizontal pole, and wherein a second of the at least two antennas is mounted a second distance from the horizontal pole that is less than the first distance from the horizontal pole.

11. The assembly defined in claim 10, wherein the first antenna and the second antenna are positioned and oriented so that they are substantially coplanar.

12. The assembly defined in claim 10, wherein the first antenna and the second antenna are mounted on a common member.

13. The assembly defined in claim 12, wherein the first and second antennas and the common member are substantially parallel.

14. The assembly defined in claim 10, wherein the first antenna and the second antenna are mounted on different members that are mounted to the horizontal pole, the first and second members being of different lengths.

15. The assembly defined in claim 10, wherein the horizontal pole is attached to a monopole platform.

16. The assembly defined in claim 10, wherein the horizontal pole is attached to a sector frame.

17. An assembly for mounting a plurality of antennas, comprising:
a mounting platform;
a horizontal pole attached to the mounting platform;
at least two members extending away from the horizontal pole; and
at least three radio frequency antennas, wherein a first of the at least three antennas is mounted on a first of the at least two members to define a first distance from the horizontal pole, and wherein a second of the at least three antennas is mounted on a second of the at least two members to define a second distance from the horizontal pole that is less than the first distance from the horizontal pole;
wherein the first antenna and the second antenna are positioned and oriented so that they are substantially coplanar.

18. The assembly defined in claim 17, wherein the first member and the second member are of the same length.

19. An assembly for mounting a plurality of antennas, comprising:
a horizontal pole defining a first axis; and
at least two radio frequency antennas mounted in positions near the horizontal pole, the at least two radio frequency antennas defining a second axis that is non-parallel with the first axis.

20. The assembly defined in claim 19, further comprising a first member used to mount a first of the at least two radio frequency antennas relative to the horizontal pole, and a second member used to mount a second of the at least two radio frequency antennas relative to the horizontal pole

21. The assembly defined in claim 20, further comprising: a first mounting arrangement including a first mounting bracket, the first mounting arrangement employed to mount the first member to the horizontal pole; and a second mounting arrangement including a second mounting bracket, the second mounting arrangement employed to mounted the second mounting member to the horizontal pole.

22. The assembly defined in claim 21, wherein the first mounting bracket is configured to be adjustable relative to the first mounting bracket along an axis defined by the first mounting member.

23. The assembly defined in claim 21, wherein the first mounting bracket is mounted to the horizontal pole via U-bolts.

24. The assembly defined in claim 21, wherein the first member and first mounting bracket are configured to be rotatably adjustable about a vertical axis relative to the horizontal pole.

25. An assembly for mounting a plurality of antennas, comprising:
a mounting platform;
a horizontal pole attached to the mounting platform;
a member extending away from the horizontal pole; and
a radio frequency antenna mounted on the member;
wherein the member is mounted to the horizontal pole to be selectively rotatable about a vertical axis.
